(19) United States
(12) Patent Application Publication
(10) Pub. No.: US 2007/0069993 A1
(43) Pub. Date: Mar. 29, 2007

(54) Display apparatus

(75) Inventor: Masao Kato, Suita-shi (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-shi (JP)

(21) Appl. No.: 11/498,921

(22) Filed: Aug. 3, 2006

(30) Foreign Application Priority Data
Sep. 26, 2005 (JP) 2005-278607

(51) Int. Cl. G09G 3/30

(52) U.S. Cl. 345/76

(57) ABSTRACT

A driving circuit includes a power supply portion for supplying a voltage, an electric current path switching portion for switching a path of an electric current, a resonance portion in which the drive voltage is generated, and a resonance suppressing portion for suppressing the drive voltage generated in the resonance portion in a critical state. The drive voltage has at least one pair of continuous waveforms with different polarities with respect to a reference voltage. The waveforms of the drive voltage have a peak voltage higher than the voltage supplied from the power supply portion. The waveforms converge after the at least one pair of continuous waveforms with different polarities with respect to the reference voltage is applied to the display element. This makes it possible to supply a drive voltage having a waveform in which a positive polarity and a negative polarity are reversed periodically to a display element with a simple configuration and a low power loss.

### BACKGROUND OF THE INVENTION

1. Field of the Invention

The present invention relates to a display apparatus including a light-emitting element, for example, an inorganic EL (electroluminescent) element or the like.

2. Description of Related Art

An inorganic EL element has a structure in which a light-emitting layer including a phosphor layer and a dielectric layer is sandwiched between a pair of electrodes, and emits light when a voltage pulse is applied between the pair of electrodes. In a display panel of a display apparatus including the inorganic EL element (hereinafter, referred to as “an inorganic EL display apparatus”), a large number of pixels formed of the inorganic EL elements are arranged in a matrix. For example, a plurality of stripe-shaped electrodes that serve as data electrodes and are in parallel with a first direction are spaced from each other on a substrate made of glass or the like, a light-emitting layer is formed on these data electrodes, and a plurality of stripe-shaped electrodes that serve as scanning electrodes and are in parallel with a second direction perpendicular to the first direction are spaced from each other on the light-emitting layer. In this way, the inorganic EL element obtained by sandwiching the light-emitting layer between the data electrode and the scanning electrode is formed at each of the intersections of the stripe-shaped electrodes as the data electrodes and the stripe-shaped electrodes as the scanning electrodes. Thus, a passive-matrix display panel in which the inorganic EL elements serving as display elements are arranged two-dimensionally is formed.

Since the inorganic EL element is a capacitive element, an electric current contributing to light emission when a drive voltage is applied to the light-emitting layer behaves similarly to a charging current when a voltage is applied to a capacitor. The electric current flows for a period as short as several microseconds, and a voltage applied after the electric current flows does not contribute to the light emission. Therefore, it is not possible to achieve a continuous light emission by applying a direct voltage as the drive voltage.

Accordingly, the inorganic EL display apparatus is driven by a so-called field reversed driving, which reverses the polarity of a voltage applied to the light-emitting layer for each field (see JP 2001-312245 A, for example). For that purpose, for example, a scanning-side driving circuit that drives the scanning electrodes has an output element for generating a voltage whose polarity is negative with respect to the data electrodes and an output element for generating a voltage whose polarity is positive with respect to the same. On the other hand, a data-side driving circuit that drives the data electrodes has an output element for generating a modulation voltage applied to the light-emitting layer. This makes it possible to apply an alternating pulse having an excellent symmetry to the light-emitting layer in a period of each frame, thus allowing a highly-reliable display.

However, the reversed driving requires a pair of fields that have different voltage polarities for composing one frame, so that the number of fields is twice as many as that of frames. It is not possible to obtain an optimal image quality without using a pair of fields.

When the number of fields increases, an invalid period also increases, so that it is not possible to respond to a display having a large number of pixels. Accordingly, a driving method of applying successive pulse voltages having different polarities within one line selection period for one frame has been suggested (see JP 2682886 B, for example).

As described above, in order to apply a voltage whose polarity is reversed periodically to the light-emitting layer, the driving circuit of the conventional inorganic EL display apparatus includes a positive-polarity power supply and a negative-polarity power supply that generate a positive-polarity driving waveform and a negative-polarity driving waveform, respectively.

Since a threshold voltage for causing the inorganic EL element to emit light is about 200 V, the driving circuit has to apply a relatively high drive voltage to the inorganic EL element. Thus, if the positive-polarity power supply and the negative-polarity power supply are provided separately, the apparatus becomes complicated, which presents an obstacle to cost reduction.

Furthermore, a power supply portion in the scanning-side driving circuit has to generate a positive-polarity voltage and a negative-polarity voltage successively within one line selection period for one frame. The range of the voltage switched at this time is very wide, that is, about +200 V to −200 V, so that the switching element consumes much electric power. Also, it is not possible to discharge an electric charge accumulated in the inorganic EL element at the time of switching the polarities, thus impairing the light emission. Further, a display apparatus with a large number of pixels has a small margin for the switching time. Moreover, two kinds of the driving circuits, which are for the positive polarity and the negative polarity, are needed for applying high voltages with different polarities, thus further raising costs.

### SUMMARY OF THE INVENTION

It is an object of the present invention to solve the conventional problems described above and to provide a display apparatus including a driving circuit capable of applying a drive voltage having a waveform in which a positive polarity and a negative polarity are reversed periodically to a display element with a simple configuration and a low power loss.

A display apparatus according to the present invention includes a display element, and a driving circuit for applying a drive voltage to the display element. The driving circuit includes a power supply portion for supplying a voltage, an electric current path switching portion for switching a path of an electric current, a resonance portion in which the drive voltage is generated, and a resonance suppressing portion for suppressing the drive voltage generated in the resonance portion in a critical state. The drive voltage has at least one pair of continuous waveforms with different polarities with respect to a reference voltage. The waveforms of the drive voltage have a peak voltage higher than the voltage supplied from the power supply portion. The waveforms converge after the at least one pair of continuous waveforms with different polarities with respect to the reference voltage is applied to the display element.

Here, the “reference voltage” means an electric potential of one terminal in the case where the drive voltage is applied to the other terminal, for example, when the display element has two terminals. The “polarities with respect to a reference voltage” means a relative potential polarity obtained by subtracting the electric potential of the one terminal (the reference voltage) from the drive voltage applied to the other terminal. The “one pair of . . . with different polarities” means a pair of a waveform having a positive polarity and a waveform having a negative polarity. Also, the “at least one pair of continuous waveforms” means waveforms in which the waveform having the positive polarity and the waveform having the negative polarity alternate with substantially no period in which the voltage is 0 interposed therebetween. The “suppressing the drive voltage . . . in a critical state” means that, after the drive voltage has at least one pair of continuous waveforms with different polarities with respect to the reference voltage, the waveforms of the drive voltage converge.

### BRIEF DESCRIPTION OF THE DRAWINGS

FIG. 1 is a block diagram showing a schematic configuration of an embodiment of a display apparatus according to the present invention.

FIG. 2 is a circuit diagram showing an example realizing the display apparatus shown in FIG. 1.

FIG. 3 shows waveforms of an electric current and a voltage of a display element and a voltage supplied from a pulse power supply in an example of the display apparatus shown in FIG. 2.

FIG. 4 shows waveforms of the electric current of the display element and an output-side electric current of a photo coupler in an example of the display apparatus shown in FIG. 2.

FIG. 5 shows waveforms of the electric current of the display element and an electric current of a diode in an example of the display apparatus shown in FIG. 2.

FIG. 6 shows waveforms of the electric current of the display element and an electric current of a resonance suppressing resistor in an example of the display apparatus shown in FIG. 2.

FIG. 7 is a block diagram showing a schematic configuration of another embodiment of the display apparatus according to the present invention.

FIG. 8 is a block diagram showing a schematic configuration of yet another embodiment of the display apparatus according to the present invention.

FIG. 9 is a circuit diagram showing an example realizing the display apparatus shown in FIG. 8.

FIG. 10 is a circuit diagram showing an example of a matrix-type display apparatus using an inorganic EL element.

FIG. 11 is a circuit diagram showing another example of the matrix-type display apparatus using the inorganic EL element.

### DETAILED DESCRIPTION OF THE INVENTION

In accordance with the present invention, a resonance voltage waveform having a positive polarity and a negative polarity can be generated using a power supply portion for supplying a voltage of a positive (or negative) polarity alone and applied to a display element as a drive voltage. Furthermore, the voltage supplied from the power supply portion is sufficient as long as it is about ¼ of a peak voltage (p-p) of a waveform of the drive voltage applied to the display element. Also, one of the positive voltage and the negative voltage of the drive voltage waveform does not depend on the voltage supplied from the power supply portion. Consequently, it is possible to save power and reduce wirings for controlling the power supply, so that the reduction in the power consumption and cost of the driving circuit can be achieved.

In the above-described display apparatus according to the present invention, it is preferable that the display element is a capacitive element, and the resonance portion includes the display element.

This makes it possible to utilize the display element as part of a resonance circuit, thus achieving a smaller number of components and simplification of the circuit. Also, resonance occurs in the resonance portion at the same time with light emission.

It is preferable that the above-described display apparatus according to the present invention includes a plurality of the display elements and further includes a selecting portion for selecting from the plurality of the display elements the display element to which the drive voltage is to be applied.

Accordingly, any one or more of the plurality of the display elements alone can be caused to emit light selectively by a resonance voltage waveform. Thus, a segment driving can be achieved, for example.

The above-described display apparatus according to the present invention further may include a plurality of scanning electrodes that are in parallel with a first direction and a plurality of data electrodes that are in parallel with a second direction perpendicular to the first direction. In this case, it is preferable that the display element is arranged at each of a plurality of intersections of the plurality of scanning electrodes and the plurality of data electrodes. It also is preferable that the driving circuit is provided as a scanning-side driving circuit for applying a scan voltage to the display element on the scanning electrode via the scanning electrode. It also is preferable that the display apparatus further includes a scanning-side selecting portion for selecting from the plurality of scanning electrodes the scanning electrode to which the scanning-side driving circuit applies the scan voltage.

In this way, it is possible to achieve a display with a large number of pixels conducting matrix driving by line-sequential scanning, plane-sequential scanning, point-sequential scanning or the like. Thus, the display apparatus according to the present invention can be applied to a TV, a monitor or the like. Also, since the scan voltage has the above-noted resonance voltage waveform of the present invention, power can be saved.

In this case, it is preferable that the driving circuit is provided also as a data-side driving circuit for applying a data voltage to the display element on the data electrode via the data electrode. It also is preferable that the display apparatus further includes a data-side selecting portion for selecting from the plurality of data electrodes the data electrode to which the data-side driving circuit applies the data voltage.

In this way, since the data voltage also has the above-noted resonance voltage waveform of the present invention, it is possible to achieve a display with a large number of pixels with further power savings.

In the above display apparatus, it is preferable that a period in which a waveform of the voltage supplied from the power supply portion of the driving circuit serving as the scanning-side driving circuit has a value other than 0 is shorter than a period in which the scan voltage is applied to the scanning electrode that is selected. It also is preferable that a period in which a waveform of the voltage supplied from the power supply portion of the driving circuit serving as the data-side driving circuit has a value other than 0 is shorter than a period in which the data voltage is applied to the data electrode that is selected. Here, the “period in which a waveform of the voltage . . . has a value other than 0” means a unit pulse width in the case where the power supply portion applies a pulse voltage, for example.

In this way, the power supply portion does not have to supply the voltage constantly and only needs to supply the voltage for a necessary minimum period of initially generating the resonance voltage waveform. Therefore, power can be saved.

It is preferable that the electric current path switching portion includes at least two switching elements. Here, the “switching elements” can be illustrated as a diode, a transistor or a FET, for example.

This makes it possible to use general-purpose switch components, thereby achieving an inexpensive electric current path switching portion.

It is preferable that the resonance portion includes at least one inductive element. Here, the “inductive element” can be illustrated as a coil, for example.

This makes it possible to achieve an inexpensive resonance portion.

It is preferable that the inductive element is a variable inductive element.

Accordingly, variations of a resonance frequency caused by variations of the capacitive element constituting the resonance portion can be corrected by adjusting the inductance of the inductive element.

It is preferable that the resonance suppressing portion includes at least one resistor.

Accordingly, by selecting the resistance of the resistor optimally, when a resonance electric current flows in the resistor, it is possible to suppress this resonance to a critical vibration, so that the generation of an undesired resonance can be suppressed.

It is preferable that the resistor is a variable resistor.

Accordingly, the resistance of the resistor is adjusted so as to adjust a damping factor of the critical vibration, thereby obtaining a desired drive waveform.

It is preferable that the display element is an inorganic EL element including a dielectric layer and a phosphor layer.

In this way, the inorganic EL element, which needs to be driven at a high voltage with varying polarity, can be driven while achieving power savings and low cost.

It is preferable that a period in which a waveform of the voltage supplied from the power supply portion has a value other than 0 is ½ of a period of a part of the waveform of the drive voltage having a positive polarity or a negative polarity with respect to the reference voltage.

This makes it possible to equalize a positive-side peak voltage value and a negative-side peak voltage value of the continuous positive-negative drive waveform of the drive voltage, allowing an optimal driving.

It is preferable that the power supply portion supplies a voltage having only one of a positive polarity and a negative polarity with respect to the reference voltage.

This eliminates the need for providing both of the positive-polarity power supply and the negative-polarity power supply in the driving circuit, thus making it possible to simplify the wirings for controlling the power supply and reduce the cost of the driving circuit.

The following is a description of embodiments of the present invention, with reference to the accompanying drawings.

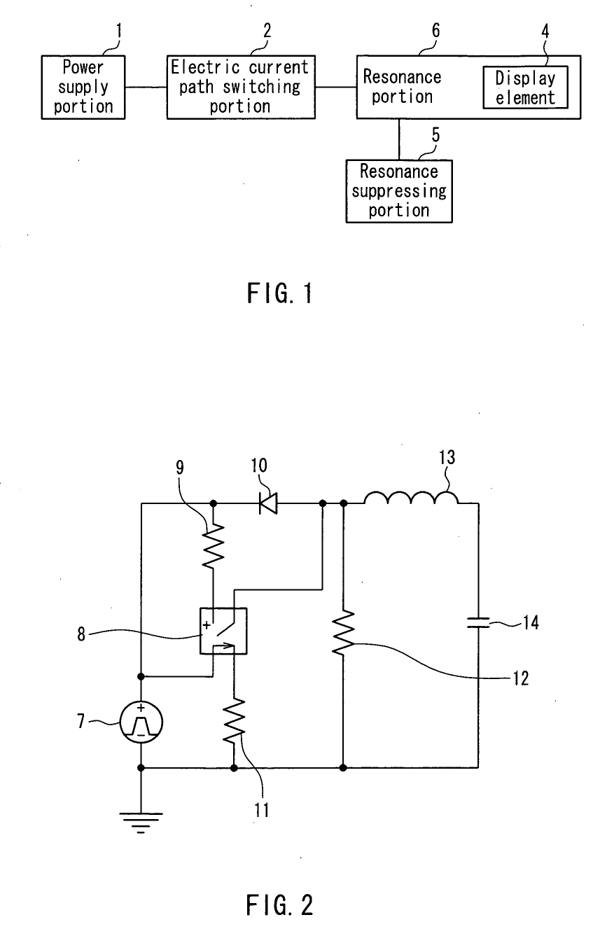

FIG. 1 is a block diagram showing a schematic configuration of an embodiment of a display apparatus according to the present invention. The display apparatus according to the present invention includes a power supply portion 1 that supplies a positive or negative voltage for a period necessary for generating resonance, an electric current path switching portion 2 that switches a path of an electric current, thereby generating resonance for a necessary period and damping the resonance thereafter, a resonance portion 6 in which a resonating drive voltage is generated, and a resonance suppressing portion 5 that generates a critical vibration after the necessary period of resonance so as to stop the resonance. The resonance portion 6 includes a display element 4.

The operation of the display apparatus shown in FIG. 1 will be described. A voltage supplied from the power supply portion 1 passes through the electric current path switching portion 2 and generates resonance in the resonance portion 6, while causing the display element 4 to emit light simultaneously. When the voltage supply is stopped after a predetermined period since the resonance starts, the path of the electric current in the electric current path switching portion 2 is switched. No electric current flows in the electric current path switching portion 2 since then, and the electric current flowing in the display element 4 passes through the resonance suppressing portion 5, so that the resonance is stopped.

FIG. 2 is an exemplary circuit diagram for realizing the display apparatus shown in FIG. 1. The power supply portion 1 in FIG. 1 is configured by a general-purpose pulse power supply 7. The electric current path switching portion 2 in FIG. 1 is configured by resistors 9, 11, a photo coupler 8 and a diode 10. The resonance portion 6 in FIG. 1 is configured by a coil 13 and a display element 14. The resonance suppressing portion 5 in FIG. 1 is configured by a resistor 12. Although the display element 14 is shown as a single capacitor in FIG. 2, it may be either a single display element or a plurality of display elements (for example, a plurality of display elements connected in parallel with one scanning electrode) in practice. In the case of the plurality of display elements, the display element 14 means a combined capacity of these display elements.

One terminal of the pulse power supply 7 is grounded, and the other terminal thereof is connected to an input-side positive terminal of the photo coupler 8 serving as a switching element, one terminal of the resistor 9 and a cathode-side terminal of the diode 10. Another input-side terminal of the photo coupler 8 is connected to one terminal of the resistor 11. The other terminal of the resistor 11 is grounded. The other terminal of the resistor 9 is connected to an output-side positive terminal of the photo coupler 8, and another output-side terminal of the photo coupler 8 is connected to an anode-side terminal of the diode 10, one terminal of the coil 13 and one terminal of a resistor 12. The other terminal of the resistor 12 is grounded. The other terminal of the coil 13 is connected to one terminal of the display element 14. The other terminal of the display element 14 is grounded.

In the following, the operation of the display apparatus shown in FIG. 2 will be described.

When a voltage is supplied from the pulse power supply 7, an electric current flows in an input side of the photo coupler 8, so that an output side of the photo coupler 8 is turned on. Accordingly, the electric current from the pulse power supply 7 passes through the output side of the photo coupler 8, the coil 13 and the display element 14. At this time, a resonance electric current is generated in the coil 13 and the display element 14. Next, when the supply of the voltage from the pulse power supply 7 is stopped after about ¼ of a resonance period of the resonance electric current generated in the coil 13 and the display element 14, the output side of the photo coupler 8 is turned off, so that the resonance electric current passes through the diode 10 and flows into a ground plane. Then, when a voltage generated in the display element 14 reaches a negative voltage peak, no electric current flows in the diode 10 in a reverse direction, and the output side of the photo coupler 8 is turned off, so that the resonance electric current passes through the resistor 12. Since the resistance of the resistor 12 is set such that the resonance is in a critical state at this time, the resonance voltage converges.

The following is an example of the display apparatus shown in FIG. 2. A voltage of 120 V (p-0) was supplied from the pulse power supply 7 for a period of 50 μs. For the photo coupler 8 and the diode 10, general-purpose products were used. The resistor 9 was 10 Ω, the resistor 11 was 10 kΩ, the resistor 12 was 25 kΩ, the coil 13 was 300 mH, and the display element 14 was 1 nF. However, they are merely examples, and component values for the individual elements are set suitably according to targeted voltages and electric currents.

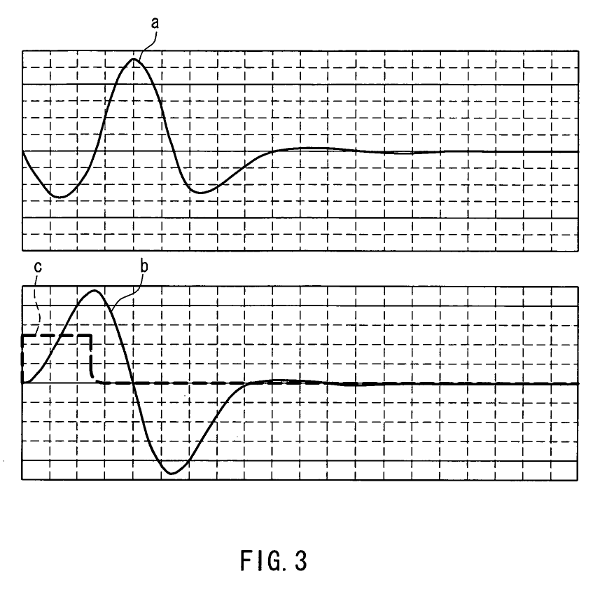

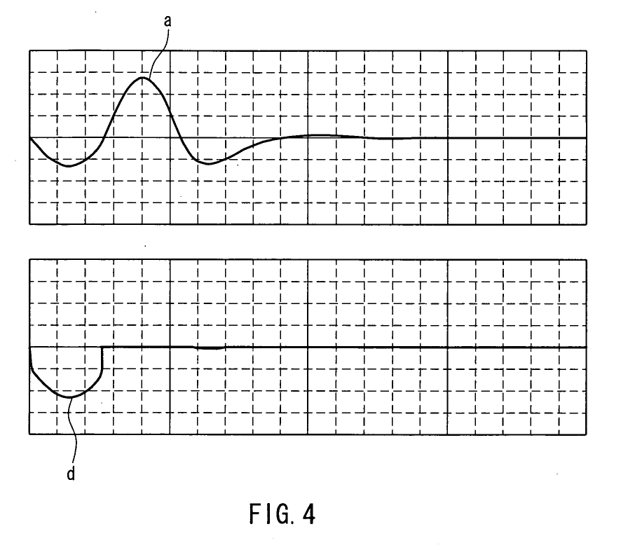

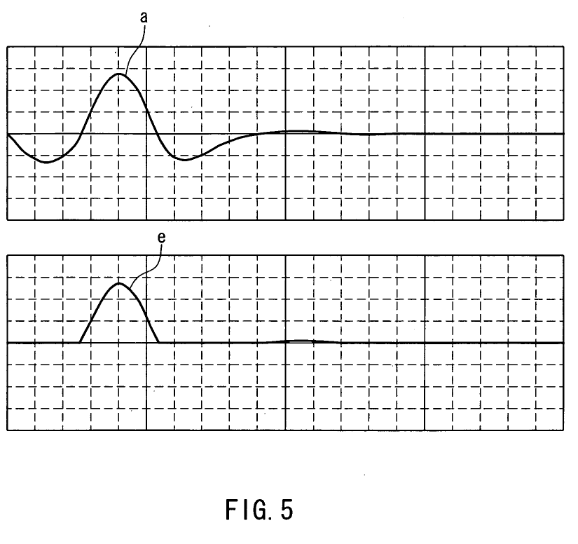

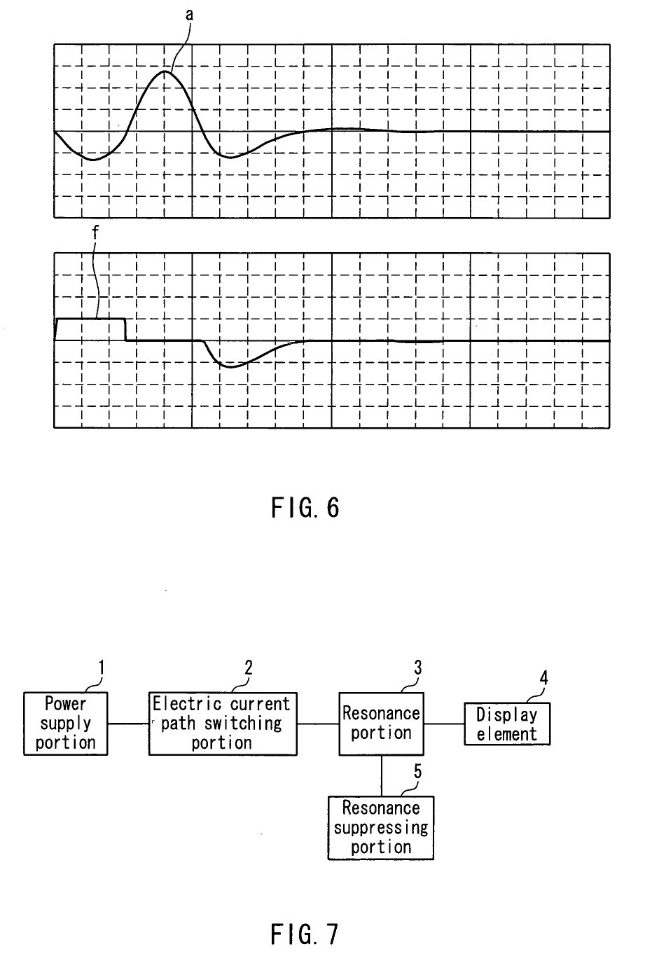

Now, waveforms of a voltage and an electric current of each portion in the example described above will be described. In FIG. 3, “a” indicates the waveform of the electric current flowing in the display element 14, which was 20.5 mA (p-p), “b” indicates the waveform of a drive voltage applied to the display element 14, which was 480 V (p-p), and “c” indicates the waveform of the voltage supplied from the pulse power supply 7, which was 120 V (p-0) supplied for the period of 50 μs. When the pulse power supply 7 started supplying a positive-polarity voltage, the waveform b of the drive voltage applied to the display element 14 rose. When b reached the peak of the positive polarity, the pulse power supply 7 stopped supplying the voltage. In FIG. 4, “d” indicates a waveform of an output-side electric current of the photo coupler 8, which was 7 mA (p-0). In FIG. 5, “e” indicates a waveform of an electric current of the diode 10, which was 11.5 mA (p-0). In FIG. 6, “f” indicates a waveform of an electric current of the resistor 12 for suppressing resonance, which was 7 mA (p-0).

As described above, with the display apparatus according to the present invention, the power supply portion that supplies a positive or negative constant voltage is used to generate a resonance voltage in the resonance portion, and this resonance voltage having a positive polarity and a negative polarity is applied as the drive voltage to the display element. At this time, the voltage supplied from the power supply portion is sufficient if it is about ¼ of a peak-to-peak (p-p) voltage necessary for driving the display element. Moreover, either the positive or negative drive voltage applied to the display element does not depend on a power supply from the power supply portion. Therefore, compared with a conventional display apparatus, it is possible to reduce wirings for controlling the power supply while saving the power. Also, in order to drive the display element 14 in the above-described example with a positive-negative alternating voltage, a switching element having withstand voltage characteristics of at least 480 V has to be used in a conventional driving circuit. However, in the above-described example of the present invention, the electric current path switching portion with 120 V withstand voltage characteristics is sufficient. Thus, the durability required for the individual elements is relaxed, making it possible to configure a driving circuit using inexpensive elements. Consequently, a high-definition and high-quality display apparatus can be achieved at low cost.

FIG. 7 is a block diagram showing a schematic configuration of another embodiment of the display apparatus according to the present invention. The display apparatus shown in FIG. 7 is different from that shown in FIG. 1 with the display element 4 included in the resonance portion 6, in that a display element 4 and a resonance portion 3 are provided separately. Although a circuit diagram for realizing the display apparatus shown in FIG. 7 will be omitted here, it also is appropriate to replace the display element 14 in FIG. 2 by a capacitor and connect the display element 4 in parallel with this capacitor, for example.

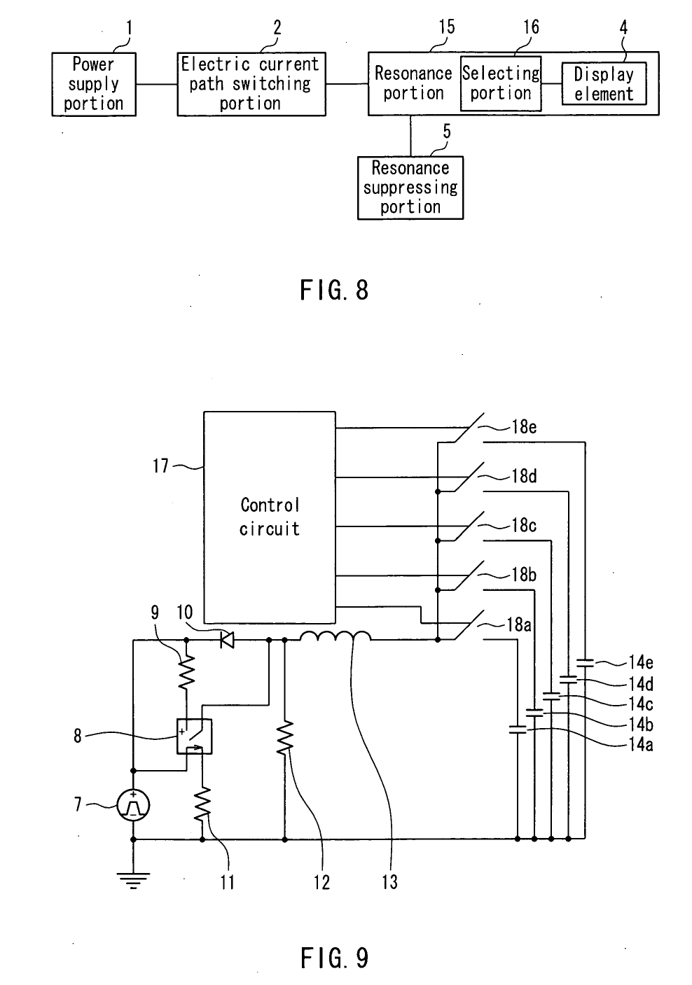

A shown in FIG. 8, a resonance portion 15 also may include a selecting portion 16. This allows a point-sequential scanning, a line-sequential scanning and a plane-sequential scanning. FIG. 9 is an exemplary circuit diagram for realizing the display apparatus shown in FIG. 8. The selecting portion 16 includes a control circuit 17 constituted by an IC or the like, and switches 18a to 18e constituted by a transistor, a FET, a driver IC or the like. Display elements 14a to 14e are connected respectively in series with the switches 18a to 18e. By controlling ON/OFF of the individual switches 18a to 18e using the control circuit 17, it is possible to select from the display elements 14a to 14e the display element to which the drive voltage is to be applied. The display elements 14a to 14e may be a single display element, a plurality of display elements connected in parallel on one line or a plurality of display elements arranged in a predetermined region. The number of the display elements and the number of the switches are not limited to five as illustrated in FIG. 9. It is appropriate to divide a plurality of display elements provided in the display apparatus into plural groups of display elements to be selected at one time and provide one switch for each of the groups of display elements.

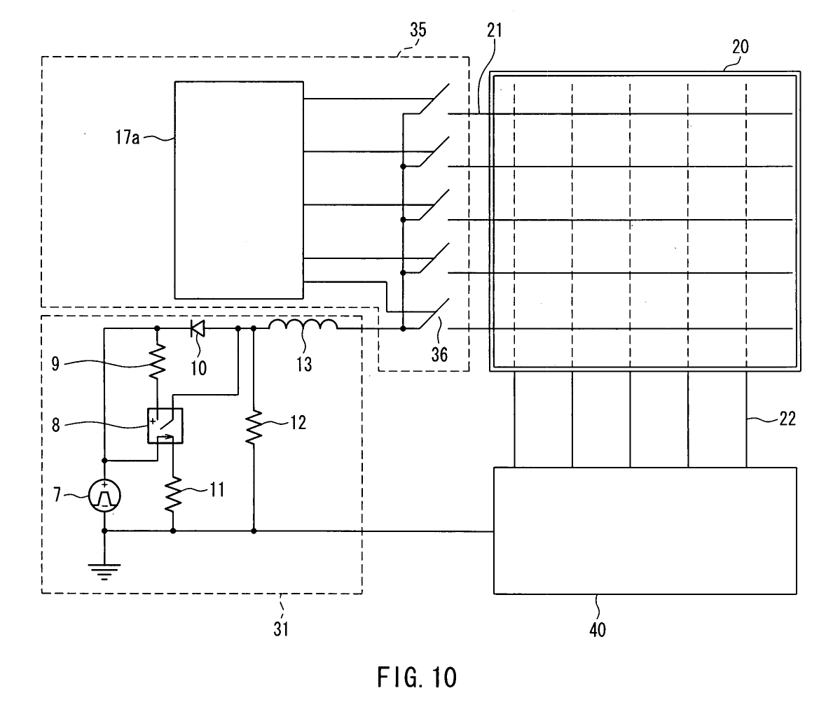

FIGS. 8 and 9 are applicable to a display apparatus conducting matrix driving. An example thereof is illustrated in FIG. 10, which is a circuit diagram showing a matrix-type display apparatus using an inorganic EL element.

An inorganic EL display panel 20, for example, includes an insulating substrate (not shown) such as a glass plate, a plurality of stripe-shaped scanning electrodes 21 that are formed on the insulating substrate and equidistantly arranged in parallel with a first direction, a plurality of stripe-shaped data electrodes 22 that are equidistantly arranged in parallel with a second direction perpendicular to the first direction so as to cross the plurality of scanning electrodes 21, and an inorganic EL light-emitting layer (not shown) provided between the plurality of scanning electrodes 21 and the plurality of data electrodes 22. Although not shown in the figure, the inorganic EL light-emitting layer has a known structure and includes, for example, a phosphor layer and a dielectric layer formed on at least one surface of the phosphor layer. At each of a plurality of intersections of the plurality of scanning electrodes 21 and the plurality of data electrodes 22, the scanning electrode 21, the data electrode 22 and the inorganic EL light-emitting layer sandwiched therebetween form a display element (an inorganic EL element). The inorganic EL display panel 20 is a passive-matrix line-sequential scanning display panel in which a plurality of the display elements are arranged two-dimensionally in a matrix as pixels.

The matrix-type display apparatus includes the above-described inorganic EL display panel 20, a scanning-side driving circuit 31 that applies a scan voltage to the display elements on the scanning electrode 21 of the inorganic EL display panel 20 via the scanning electrode 21, a scanning-side selecting portion 35 that selects from the plurality of scanning electrodes 21 the scanning electrode 21 to which the scanning-side driving circuit 31 applies the scan voltage, and a data-side driving circuit 40 that applies a data voltage according to a data signal to each of the plurality of data electrodes 22.

A control circuit, which is not shown in the figure, generates necessary signals based on a vertical synchronization signal, a horizontal synchronization signal and a data transfer clock signal that are inputted externally, and externally-inputted display signal data, etc. and supplies them to the scanning-side selecting portion 35 and the data-side driving circuit 40. The scanning-side selecting portion 35 performs line-sequential scanning driving based on the supplied signal. Also, the data-side driving circuit 40 outputs a data voltage based on the data signal according to the display signal data.

The scanning-side selecting portion 35 corresponds to the selecting portion 16 in FIG. 8 and includes a scanning-side control circuit 17a constituted by an IC or the like, and a plurality of switches 36 constituted by a transistor, a FET, a driver IC or the like. The number of the switches 36 has to be the same as that of the scanning electrodes 21. For example, when the inorganic EL display panel 20 includes n lines of the scanning electrodes 21, n switches 36 are needed. The scanning-side control circuit 17a controls the individual switches 36, thereby selecting from the plurality of scanning electrodes 21 the scanning electrode 21 to which the scan voltage is to be applied.

In this case, a period in which the waveform of the voltage supplied from a power supply portion (namely, a pulse power supply 7) of the scanning-side driving circuit 31 has a value other than 0 (a pulse width of 50 μs of the waveform c in FIG. 3 in the example described above) is set to be shorter than a period in which the scan voltage is applied to the specific scanning electrode 21 that is selected.

Elements 7 to 13 constituting the scanning-side driving circuit 31 in FIG. 10 respectively have the same roles as the elements 7 to 13 shown in FIG. 2, and thus, the description thereof will be omitted here.

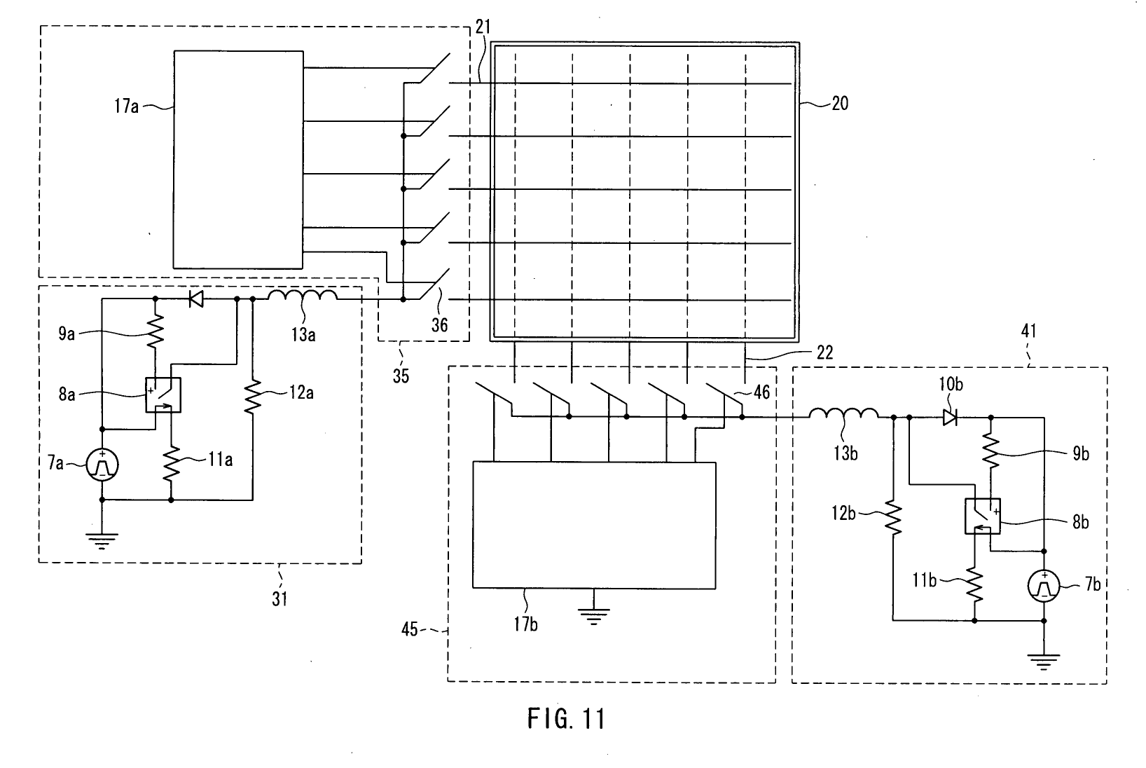

FIG. 11 is a circuit diagram showing another example of the matrix-type display apparatus using the inorganic EL display panel 20. This display apparatus includes, instead of the data-side driving circuit 40 in FIG. 10, a data-side driving circuit 41 that applies a data voltage to the display elements on the data electrode 22 of the inorganic EL display panel 20 via the data electrode 22, and a data-side selecting portion 45 that selects from the plurality of data electrodes 22 the data electrode 22 to which the data-side driving circuit 41 applies the data voltage.

The data-side selecting portion 45 corresponds to the selecting portion 16 in FIG. 8 and includes a data-side control circuit 17b constituted by an IC or the like, and a plurality of switches 46 constituted by a transistor, a FET, a driver IC or the like. The number of the switches 46 has to be the same as that of the data electrodes 22. For example, when the inorganic EL display panel 20 includes m lines of the data electrodes 22, m switches 46 are needed. The data-side control circuit 17b controls the individual switches 46 based on the data signal according to the display signal data, thereby selecting from the plurality of data electrodes 22 the data electrode 22 to which the data voltage is to be applied. For example, according to the data signal, the data control circuit 17b changes the period of applications of the data voltage to the data electrode 22 or the number of applications thereof per unit time.

In this case, a period in which the waveform of the voltage supplied from a power supply portion (namely, a pulse power supply 7b) of the data-side driving circuit 41 has a value other than 0 (a pulse width of 50 μs of the waveform c in FIG. 3 in the example described above) is set to be shorter than a period in which the data voltage is applied to the specific data electrode 22 that is selected.

Elements 7a to 13a constituting the scanning-side driving circuit 31 and elements 7b to 13b constituting the data-side driving circuit 41 in FIG. 11 respectively have the same functions as the elements 7 to 13 shown in FIG. 2, and thus, the description thereof will be omitted here.

According to the above-described display apparatus conducting the matrix driving, it is possible to save the power and lower the cost of the driving circuit of the display apparatus including the display element in each of a large number of pixels that are arranged two-dimensionally.

In the present invention, the resistors 12, 12a and 12b may be a variable resistor. This makes it possible to make a fine adjustment of damping of the resonance waveform, thereby setting an optimal waveform of the drive voltage to be applied to the display element.

Further, the coils 13, 13a and 13b may be a variable inductance. This makes it possible to make a fine adjustment of an inductance of the coils 13, 13a and 13b, thereby correcting variations in the capacity of the display element and variations in the resonance frequency.

Although the present invention is applicable to any fields with no particular limitation, it can be utilized widely in display apparatuses including a display element that is driven by applying a voltage waveform having a positive polarity and a negative polarity. For example, the present invention can be utilized in a display apparatus including an inorganic EL element.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A display apparatus comprising:
a display element; and
a driving circuit for applying a drive voltage to the display element, the driving circuit comprising
a power supply portion for supplying a voltage,
an electric current path switching portion for switching a path of an electric current,
a resonance portion in which the drive voltage is generated, and
a resonance suppressing portion for suppressing the drive voltage generated in the resonance portion in a critical state;
wherein the drive voltage has at least one pair of continuous waveforms with different polarities with respect to a reference voltage,
the waveforms of the drive voltage have a peak voltage higher than the voltage supplied from the power supply portion, and
the waveforms converge after the at least one pair of continuous waveforms with different polarities with respect to the reference voltage is applied to the display element.

2. The display apparatus according to claim 1, wherein the display element is a capacitive element, and the resonance portion comprises the display element.

3. The display apparatus according to claim 1, which comprises a plurality of the display elements and further comprises a selecting portion for selecting from the plurality of the display elements the display element to which the drive voltage is to be applied.

4. The display apparatus according to claim 1, further comprising a plurality of scanning electrodes that are in parallel with a first direction and a plurality of data electrodes that are in parallel with a second direction perpendicular to the first direction,
wherein the display element is arranged at each of a plurality of intersections of the plurality of scanning electrodes and the plurality of data electrodes,
the driving circuit is provided as a scanning-side driving circuit for applying a scan voltage to the display element on the scanning electrode via the scanning electrode, and
the display apparatus further comprises a scanning-side selecting portion for selecting from the plurality of scanning electrodes the scanning electrode to which the scanning-side driving circuit applies the scan voltage.

5. The display apparatus according to claim 4, wherein the driving circuit is provided also as a data-side driving circuit for applying a data voltage to the display element on the data electrode via the data electrode, and
the display apparatus further comprises a data-side selecting portion for selecting from the plurality of data electrodes the data electrode to which the data-side driving circuit applies the data voltage.

6. The display apparatus according to claim 4, wherein a period in which a waveform of the voltage supplied from the power supply portion has a value other than 0 is shorter than a period in which the scan voltage is applied to the scanning electrode that is selected.

7. The display apparatus according to claim 5, wherein a period in which a waveform of the voltage supplied from the power supply portion of the driving circuit serving as the data-side driving circuit has a value other than 0 is shorter than a period in which the data voltage is applied to the data electrode that is selected.

8. The display apparatus according to claim 1, wherein the electric current path switching portion comprises at least two switching elements.

9. The display apparatus according to claim 1, wherein the resonance portion comprises at least one inductive element.

10. The display apparatus according to claim 9, wherein the inductive element is a variable inductive element.

11. The display apparatus according to claim 1, wherein the resonance suppressing portion comprises at least one resistor.

12. The display apparatus according to claim 11, wherein the resistor is a variable resistor.

13. The display apparatus according to claim 1, wherein the display element is an inorganic EL element comprising a dielectric layer and a phosphor layer.

14. The display apparatus according to claim 1, wherein a period in which a waveform of the voltage supplied from the power supply portion has a value other than 0 is ½ of a period of a part of the waveform of the drive voltage having a positive polarity or a negative polarity with respect to the reference voltage.

15. The display apparatus according to claim 1, wherein the power supply portion supplies a voltage having only one of a positive polarity and a negative polarity with respect to the reference voltage.
